(19) United States
(12) Patent Application Publication
(10) Pub. No.: US 2026/0295951 A1
(43) Pub. Date: Oct. 1, 2026

(54) A DRAG-REDUCTION DEVICE, METHOD OF PRODUCING THE DRAG-REDUCTION DEVICE AND VEHICLE

(71) Applicant: Scania CV AB, Södertälje (SE)

(72) Inventors: Nathan GERHARDT, Enskededalen (SE); David LARSSON, Trosa (SE)

(73) Assignee: Scania CV AB, Södertälje (SE)

(21) Appl. No.: 19/480,430

(22) PCT Filed: Apr. 23, 2024
(86) PCT No.: PCT/SE2024/050390

§ 371 Date: Oct. 31, 2025

(30) Foreign Application Priority Data
May 8, 2023 (SE) 2350557-1

(51) Int. Cl. B29C 70/48; B29C 70/38; B29K 105/08; B29L 31/30; B62D 35/00

(52) U.S. Cl. CPC B29C 70/48; B29C 70/386; B62D 35/001; B29K 2105/0881; B29L 2031/3058

(57) ABSTRACT

A drag-reduction device for a vehicle comprising a first reinforcement zone, extending along a first longitudinal side and a second reinforcement zone extending along a second longitudinal side. The first and second reinforcement zones comprises unidirectional continuous fibers aligned parallel to a longitudinal axis of the drag-reduction device. The drag-reduction device further comprises a plurality of third reinforcement zones, spaced-apart from each other along the longitudinal axis of the drag-reduction device, each comprising unidirectional continuous fibers aligned transversal to the longitudinal axis of the drag-reduction device. A method for producing the drag-reduction device, and a vehicle comprising the drag-reduction device are also disclosed.

### TECHNICAL FIELD

The present disclosure relates in general to a method of producing a drag-reduction device for a heavy vehicle. The present disclosure further relates to a drag-reduction device for a heavy vehicle and a vehicle comprising said drag-reduction device.

### BACKGROUND

It is well known that a significant amount of air drag results when a vehicle travel is travelling along a road as a result of the air resistance, said air resistance increasing with increasing vehicle speed. The air drag must be compensated for by the propulsion power provided, and therefore increases the energy consumption of the vehicle. This in turn increases the operating costs of the vehicle and may also, depending on the type of vehicle, have a negative environmental impact due to increased emissions. In order to reduce air resistance and thereby also energy consumption of the vehicle, the vehicle may be equipped with various types of drag-reduction devices. Examples of larger sized drag-reduction devices for heavy vehicles include roof air deflectors, side skirts, side air deflectors and rear air deflectors.

Drag-reduction devices for heavy vehicles may for example be made of metallic materials, such as aluminum alloys, or of fiber reinforced polymer composites, depending on the type of drag-reduction device and desired properties thereof.

Sheet Molding Compound (SMC) is a widespread technique in the plastic manufacturing industry used to produce composite components that are strong, lightweight, and durable. The material is a kind of glass fiber reinforced polyester material which may be subjected to compression molding. The material may be provided either in ready-to-mold form, or mixed on site. The fibers may typically be chopped fibers having a length of about 3-6 mm. SMC is a manufacturing process that may be used for making large, complex components with high strength-to-weight ratios, and is therefore often used in the automotive industry today. However, SMC requires specialized equipment and is associated with high tooling costs. Another disadvantage with SMC is that the material is difficult to recycle and is not environmentally friendly.

Vehicle manufacturers are today faced with the problem of meeting a large variety of end user requirements for the vehicles produced, including different configurations and sizes of the vehicles. This in turn leads to the need of having to be able to offer a large variety of different shapes and sizes of drag-reduction devices. Modularization is a strategy that may be used to improve the ability of a vehicle manufacturer to efficiently provide end users, i.e. customers, with a high variety of customized products. The modularization concept aims at providing the highest possible customer variety in the products with minimal number of items, given defined customer applications. This strategy may also be used when producing drag-reduction devices. For example, side skirts of different lengths may be provided by producing modular parts of SMC, and assembling them together to obtain the desired final shape of the side skirt by mounting to a common metallic support structure. The metallic support structure also ensures that the assembled side skirt has sufficient mechanical properties to meet the forces to which it may be subjected during driving of the vehicle, and is thus an essential component of side skirts comprising SMC panels. Although the usage of modularization may reduce the tooling costs to meet the need for a variety of shapes and sizes of side skirts, the metallic support structure both adds weight and consumes space onboard the vehicle.

### SUMMARY

The object of the present invention is to enable cost-efficient production of drag-reduction devices having low weight and sufficient mechanical properties, and which would enable a manufacturer to offer a variety of different shapes and sizes of such drag-reduction devices.

In accordance with the present disclosure, a method of producing a drag-reduction device for a heavy vehicle is a provided. The method comprises the following steps:
(a) providing a mold adapted to the geometrical configuration of the drag-reduction device to be produced,
(b) arranging a plurality of sub-preforms in said mold such that the sub-preforms are arranged side-by-side or in a partially overlapping arrangement, with a longitudinal direction of each of the plurality of sub-preforms corresponding to a longitudinal direction of the drag-reduction device to be produced,
(c) providing a resin, either by resin application or resin infiltration, to the plurality of sub-preforms arranged in the mold, unless the plurality of sub-preforms are already fully impregnated with said resin, and
   wherein each sub-preform of the plurality of sub-preforms comprises a stack of fiber-containing layers, said fiber-containing layers comprising:
      one or more layers extending over the whole length and width of the sub-preform,
      a first tape layer extending in the longitudinal direction of the sub-preform along a first longitudinal side of, and over the entire length of, the sub-preform,
      a second tape layer arranged in parallel with and spaced-apart from the first tape layer, the second tape layer extending along a second longitudinal side of, and over the entire length, of the sub-preform,
      a plurality of third tape layers extending transversal to the longitudinal direction of the sub-preform, said plurality of third tape layers arranged in parallel and spaced-apart from each other; and
   wherein each of the first tape layer and the second tape layer comprises unidirectional continuous fibers aligned with the longitudinal direction of the sub-preform, and
   each of the plurality of third tape layers comprises unidirectional continuous fibers aligned with the transversal direction of the sub-preform.

By means of the herein described method, the drag reduction device may be produced into one single body having the desired shape and size without requiring assembly of different parts thereof, such as used in the previously known technique relying on SMC. In other words, the herein described method relies on modularization of the material used for producing the drag-reduction device, more specifically the sub-preforms, rather than modularization of different produced parts to be assembled into the drag-reduction device. This also avoids the need for a metallic support structure which may otherwise be needed in order to assembly the different produced parts and provide sufficient mechanical properties. Omittance of the metallic support structure reduces weight and also provides more space onboard the vehicle for accommodating other components, if desired.

Moreover, by using the above sub-preforms, it is possible to obtain the desired mechanical properties of the drag-reduction device. A drag-reduction device of a heavy vehicle may be subjected to considerable forces resulting from air flows, vibrations and/or uneven road conditions. By means of the herein described method, the obtain drag-reduction device will comprise reinforcement zones extending along the longitudinal sides of the drag-reduction device as well as reinforcement zones extending transversal to the longitudinal sides of the drag-reduction device. These reinforcement zones ensures that the drag-reduction device has sufficient mechanical properties to meet the most critical loads to the relevant portions of the drag-reduction device without having to considerably increase the thickness of drag-reduction device. When the drag-reduction device is a device to be mounted to a side of a heavy vehicle, the above mentioned reinforcement zones will extend substantially in a vertical plane of the vehicle.

The herein described method is particularly advantageous for production of a drag-reduction device in case it is a side skirt or a side air deflector. These are drag-reduction devices of heavy vehicles which typically have a considerable longitudinal extension, such as at least 1.5 meters and in certain cases even 4 meters or more, and which may be subjected to considerable loads during operation of the vehicle.

Each of the plurality of third tape layers may according to a preferred alternative extend between the first and second longitudinal sides of the sub-preform. This further improves the mechanical strength of the drag-reduction device.

The one or more layers extending over the whole length and width of the sub-preform may comprise a fourth layer comprising unidirectional fibers oriented with an angle of from +30° to +60° with respect to the longitudinal direction of the sub-preform, and a fifth layer comprising unidirectional fibers oriented with an angle of from −30° to −60° with respect to the longitudinal direction of the sub-preform. This further improves the mechanical strength of the drag-reduction device.

Each sub-preform of the plurality of sub-preforms may suitably be a pre-consolidated sub-preform. Thereby, the handling of the sub-preforms may be facilitated, which in turn facilitates the production of the drag-reduction device and improves the quality thereof.

The sub-preforms may be produced by automated tape layering. This has the advantage of precise manufacturing of the sub-preforms which thereby increases the quality thereof as well as the resulting drag-reduction device. More specifically, the orientation of the fibers may be more accurately controlled. Furthermore, automated tape layering has the advantage of minimizing the waste.

The step of providing a mold adapted to the geometrical configuration of the drag-reduction device to be produced (i.e. step a) may comprise assembling a plurality of modular mold sections. Thereby, the herein described method may also use the strategy of modularization also for providing the mold, which avoids the need for providing a separate mold for each possible size and configuration of the drag-reduction device. This further reduces the manufacturing costs when a large variety of different sizes and configurations of drag-reduction devices needs to be offered.

Each of the plurality of modular mold sections may have a mold surface corresponding to the geometrical configuration of a predefined longitudinal portion of the drag-reduction device to be produced.

Moreover, the present disclosure provides a drag-reduction device for a land-based heavy vehicle, such as a side skirt or a side air deflector. The drag-reduction device has a longitudinal axis and two opposing longitudinal sides and is made of a fiber reinforced material. The drag-reduction device comprises:
a first reinforcement zone, extending along a first longitudinal side of the two opposing longitudinal sides, said first reinforcement zone comprising unidirectional continuous fibers aligned parallel to the longitudinal axis of the drag-reduction device,
a second reinforcement zone, extending along a second longitudinal side of the two opposing longitudinal sides and being spaced-apart from the first reinforcement zone, said second reinforcement zone comprising unidirectional continuous fibers aligned parallel to the longitudinal axis of the drag-reduction device,
a plurality of third reinforcement zones, spaced-apart from each other along the longitudinal axis of the drag-reduction device, each comprising unidirectional continuous fibers aligned transversal to the longitudinal axis of the drag-reduction device.

In view of the different reinforcement zones, the drag reduction device according to the present disclosure does not need a metallic support structure. Thereby, the drag-reduction device according to the present disclosure enables a reduced drag coefficient of a vehicle with minimal added weight, and thereby reduces energy consumption of the vehicle. Furthermore, the drag-reduction device does not suffer from the recycling problems as previously known drag-reduction devices of SMC.

The drag-reduction device according to the present disclosure may suitably have a longitudinal extension of at least 1.5 meters. In other words, the drag-reduction device may be a large sized drag-reduction device of a heavy vehicle.

The present disclosure further provides a vehicle comprising the drag-reduction device described above. The vehicle may be a land-based heavy vehicle, such as a truck or a trailer.

### BRIEF DESCRIPTION OF DRAWINGS

FIG. 1 illustrates a side view of an example of a land-based heavy vehicle,

FIG. 2 schematically illustrates a side view of a prior art side skirt for a heavy vehicle,

FIG. 3 schematically illustrates a top view of a first exemplifying embodiment of a sub-preform which may be used in the herein described method for producing a drag-reduction device for a heavy vehicle,

FIG. 4 schematically illustrates a cross-sectional view of a second exemplifying embodiment of a sub-preform which may be used in the herein described method for producing a drag-reduction device for a heavy vehicle,

FIG. 5 represents a flowchart schematically illustrating an exemplifying embodiment of the herein described method for producing a drag-reduction device for a heavy vehicle,

FIG. 6 schematically illustrates an exploded top view of a female mold part of a mold comprising a plurality of modular mold sections,

FIG. 7 schematically illustrates a top view of an example of how a plurality of sub-preforms may be arranged in a mold in accordance with the herein described method, and

FIG. 8 schematically illustrates a side view of one exemplifying embodiment of the drag-reduction device according to the present disclosure.

### DETAILED DESCRIPTION

The invention will be described in more detail below with reference to exemplifying embodiments and the accompanying drawings. The invention is however not limited to the exemplifying embodiments discussed and/or shown in the drawings, but may be varied within the scope of the appended claims. Furthermore, the drawings shall not be considered drawn to scale as some features may be exaggerated in order to more clearly illustrate the invention or features thereof.

The term “preform” is used herein to describe an arrangement of stacked fiber-containing layers which may, or may not, be impregnated with resin, such as a thermoplastic resin. The term “sub-preform” is herein used to describe a preform which has a size not sufficient to produce the intended device. In other words, the term “sub-preform” is herein used to illustrate that the size of such a preform is smaller than the size of the drag-reduction device to be produced, such that a plurality of sub-preforms are necessary to achieve the intended size and configuration of the drag-reduction device.

Furthermore, a distinction is made in the present disclosure between a “layer” and a “tape layer”. A layer is a substantially two-dimensional component of arbitrary extension in the various directions of a two-dimensional plane. In contrast, a “tape layer” is a substantially two-dimensional layer which has a considerably longer extension in first direction of a two-dimensional plane than in a second direction of the two-dimensional plane, the second direction being perpendicular to the first direction.

The present disclosure provides a method for producing a drag-reduction device, comprising or consisting of continuous fiber reinforced plastics (CoFRP), for a heavy vehicle. The herein described method has primarily been developed for producing a side skirt, or a side air deflector (also known as a cab side air deflector), for a wheeled land-based heavy vehicle. However, the herein described method may also be utilized for producing other drag-reduction devices for land-based heavy vehicles, in particular larger sized drag-reduction devices, such as rear air deflectors (sometimes also referred to as boat tails) or roof air deflectors.

The method of producing a drag-reduction device for a heavy vehicle according to the present disclosure comprises the following steps:
(a) providing a mold adapted to the geometrical configuration of the drag-reduction device to be produced,

(b) arranging a plurality of sub-preforms in said mold such that the sub-preforms are arranged side-by-side or in a partially overlapping arrangement, with a longitudinal direction of each of the plurality of sub-preforms corresponding to a longitudinal direction of the drag-reduction device to be produced,

(c) providing a resin, either by resin application or resin infiltration, to the plurality of sub-preforms arranged in the mold, unless the plurality of sub-preforms are already fully impregnated with said resin, and

(d) heat treating so as to cure the resin.

It should here be noted that the mold typically comprises a female mold part and a male mold part. The sub-preforms are typically arranged in the female mold part. Thereafter, the male mold part may be placed on top of the female mold part.

The sub-preforms are typically flat sub-preforms and may therefore be described as two-dimensional. In order to obtain the desired three-dimensional shape of the drag-reduction device, the method may further comprise a step of forming the sub-preforms to intended three-dimensional shape using the mold. Said forming step may be performed prior to, or during, step (d). According to some embodiments, said forming step is performed after step (b), but prior to step (c). The forming step may comprise pressing the female mold part and the male mold part together.

The herein described method may preferably be a thermoforming process. In such a case, flat sub-preforms may be produced by automated tape layering and thereafter subjected to pre-consolidation. In automated tape layering, several stripes of unidirectional tapes (also known as UD tapes) are laid adjacent to each other to form complete layers of a sub-preform, and may also be used for laying individual tape layers where desired. Unidirectional tapes comprises unidirectionally aligned reinforcing fibers embedded in a thermoplastic matrix. Pre-consolidation may comprise heating the tape layered sub-preforms above the melting temperature of the polymer followed by cooling while applying pressure. In order to produce the final intended three-dimensional shape of the drag-reduction device, the pre-consolidated sub-preforms are, after having been arranged in the mold as described above, subjected to thermo-stamping. Thermo-stamping is an example of the above described forming step.

According to another alternative, the herein described method may be a thermoforming process but in which automated tape layering is not used for producing the sub-preforms. Instead, at least one organosheet and unidirectional tapes are used to produce the sub-preforms. Organosheets are fully impregnated sheets comprising a woven fiber architecture, and which may often be pre-consolidated.

Alternatively, the herein described method may be a resin transfer molding process. In such a case, the flat sub-preforms are pre-consolidated and thereafter subjected to preforming to intended three-dimensional geometrical configuration, followed by resin infiltration plus curing. The preforming is typically performed in a different mold than the mold in which resin-infiltration and curing is performed. In case the herein described method is a resin transfer molding process, step (a) of the herein described method may comprise providing a shaping mold adapted to the geometrical configuration of the drag-reduction device to be produced, and step (b) may further comprise joining the plurality of sub-preforms to each other. Moreover, the method in such a case comprises shaping the plurality of sub-preforms to a net-shaped preform in the shaping mold, and transferring the net-shaped to a resin transfer molding mold. Steps (c) and (d) are thereafter performed in the resin transfer molding mold. Alternatively, in case the method is a resin transfer molding process, step (a) comprises providing a resin transfer molding mold adapted to the geometrical configuration of the drag-reduction device to be produced and the method comprises an additional step of net-shaping each individual pre-form in a shaping mold corresponding the relevant (longitudinal) portion of the drag-reduction device to be produced. Moreover, step (b) comprises arranging the plurality of sub-preforms, which have been net-shaped, in the resin transfer molding mold. Steps (c) and (d) are thereafter performed in the resin transfer mold.

According to yet an alternative, the herein described process may be a wet compression molding process. In such a case, resin is applied to the sub-preforms before these are arranged in the mold in step (b) (in other words, step (c) is omitted). Moreover, the method comprises forming, pressing and heat-treating so as to cure the resin inside the mold.

Each sub-preform of the plurality of sub-preforms comprises a stack of fiber-containing layers comprising:
one or more layers extending over the whole length and width of the sub-preform,
a first tape layer extending in the longitudinal direction of the sub-preform along a first longitudinal side of, and over the entire length of, the sub-preform,
a second tape layer arranged in parallel with and spaced-apart from the first tape layer, the second tape layer extending along a second longitudinal side of, and over the entire length, of the sub-preform, and
a plurality of third tape layers extending transversal to the longitudinal direction of the sub-preform, said plurality of third tape layers arranged in parallel and spaced-apart from each other.

Each of the first and second tape layers mentioned above comprises unidirectional continuous fibers aligned with the longitudinal direction of the sub-preform. Furthermore, each of the plurality of third tape layers comprises unidirectional continuous fibers aligned with the transversal direction of the sub-preform. Preferably, each of the plurality of third tape layers extends between the first and second longitudinal sides of the sub-preform.

Continuous fibers are high-performance fibers characterized by having a very high length-to-diameter ratio. When the fibers are aligned, they provide maximum strength, but only along the direction of alignment. The composite is considerably weaker along other directions and is therefore highly anisotropic. Therefore, the sub-preforms used according to the present method comprises both the first and second tape layers as well as the plurality of third tape layers as described above.

The above mentioned at least one layer extending over the whole length and width of the sub-preform may according to various embodiments comprise a fourth layer comprising unidirectional fibers oriented with an angle of from +30° to +60° with respect to the longitudinal direction of the sub-preform, and a fifth layer comprising unidirectional fibers oriented with an angle of from −30° to −60° with respect to the longitudinal direction of the sub-preform. Alternatively, or additionally, the at least one layer extending over the whole length and width of the sub-preform may comprise a weaved structure of continuous fibers.

As previously mentioned, the present method comprises a step of providing a mold adapted to the geometrical configuration of the drag-reduction device to be produced. The mold may suitably consist of a plurality of modular mold sections assembled together in dependence of the desired geometrical configuration of the drag-reduction device to be produced. Thereby, the tooling costs in case of seeking to produce a large variety of different configurations of the drag-reduction device is reduced. Thus, the step of providing a mold adapted to the geometrical configuration of the drag-reduction device to be produced may comprise assembling a plurality of modular mold sections. Each mold section of the modular mold sections may suitably have a mold surface corresponding to the geometrical configuration of a predefined longitudinal portion of the drag-reduction device to be produced. In other words, the mold provided may suitably comprise a plurality of modular mold sections arranged successively along the longitudinal extension of the drag-reduction device to be produced.

The present disclosure further provides a drag-reduction device for a land-based heavy vehicle, such as a side skirt or a side air deflector. The drag-reduction device has a longitudinal axis and two opposing longitudinal sides and is made of a fiber reinforced material. More specifically, the drag-reduction device is made of continuous fiber reinforced plastics. The drag-reduction device comprises:
a first reinforcement zone, extending along a first longitudinal side of the two opposing longitudinal sides, said first reinforcement zone comprising unidirectional continuous fibers aligned parallel to the longitudinal axis of the drag-reduction device,
a second reinforcement zone, extending along a second longitudinal side of the two opposing longitudinal sides and being spaced-apart from the first reinforcement zone, said second reinforcement zone comprising unidirectional continuous fibers aligned parallel to the longitudinal axis of the drag-reduction device,
a plurality of third reinforcement zones, spaced-apart from each other along the longitudinal axis of the drag-reduction device, each comprising unidirectional continuous fibers aligned transversal to the longitudinal axis of the drag-reduction device.

The drag-reduction device is preferably a large sized drag-reduction device, and may thus have a longitudinal extension of at least 1.5 meters. According to some embodiments, the drag-reduction device may have a longitudinal extension of at least 2 meters, or even at least 3 meters. The longitudinal extension of the drag-reduction device may for example be less than 5 meters, or less than 4.5 meters.

The drag-reduction device according to the present disclosure is preferably a single piece drag-reduction device meaning that does not consist of a plurality of different pre-produced components assembled together in order to obtain a desired length of the drag-reduction device.

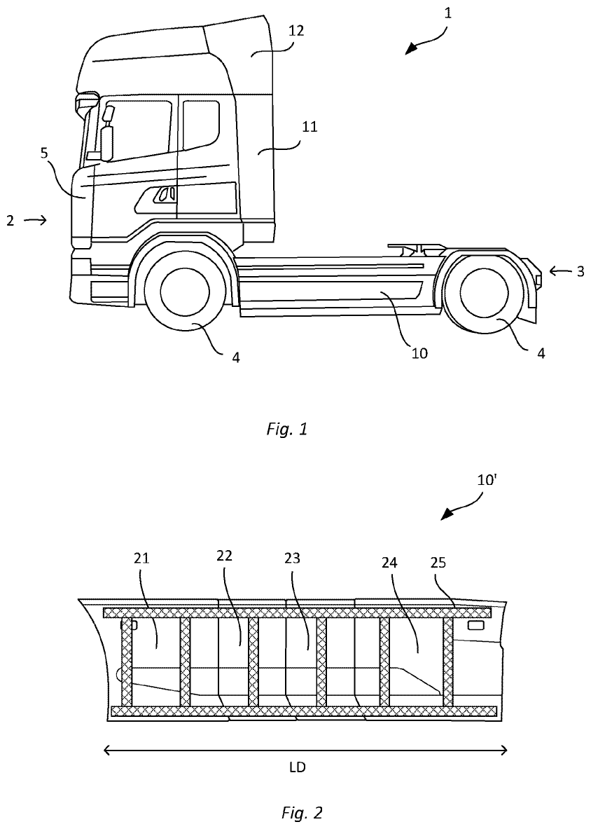

FIG. 1 illustrates a side view of an example of a land-based heavy vehicle 1, here illustrated as a pulling truck. The vehicle 1 has a front side 2 and a rear side 3, between which lateral sides of the vehicle extend. The vehicle 1 comprises a plurality of ground engaging wheels 4.

The illustrated vehicle 1 comprises a first side skirt 10 arranged to extend longitudinally along a lateral side of the vehicle. It should here be noted that the vehicle may typically also comprise a second side skirt arranged along the other lateral side of the vehicle. A side skirt is a component designed to reduce or control the flow of air entering the undercarriage region from the side of the vehicle. Air flow passing under a vehicle imparts a drag force when it impinges on and flows around the undercarriage components attached to or constituting a part of the underside of the vehicle, and a side skirt is thus able to considerably reduce said drag force.

Similarly, a drag force may be created by the air flow in the space behind the rear wall of the cab. This may be considerably reduced by a roof air deflector and side air deflectors, which are both configured to guide the air flow so as to not enter said space.

Therefore, the illustrated vehicle 1 further comprises a side air deflector 11, which may be mounted to a rear side of a driver's cab 5 of the vehicle. The side air deflector 11 is arranged such that it extends longitudinally in the vertical direction of the vehicle 1. The illustrated vehicle 1 also comprises a roof air deflector 12. The roof air deflector 12 may be mounted to the driver's cab 5. In contrast to the side skirt 10, and the side air deflector 11, the roof air deflector 12 extends substantially over the entire width of the vehicle 1.

In the following, the herein described method will be exemplified with reference to production of a side skirt for sake of clarity. However, the method is not limited to production of a side skirt, but may also be utilized for producing other drag-reduction devices for a heavy vehicle as previously discussed.

FIG. 2 schematically illustrates an example of a prior art side skirt 10′ for a heavy vehicle, such as the vehicle 1 shown in FIG. 1. The side skirt 10′ is shown seen from a side intended to face towards the undercarriage of the vehicle. The side skirt 10′ comprises a first end portion 21, a first central portion 22, a second central portion 23, and a second end portion 24 arranged consecutively along the longitudinal extension LD of the side skirt 10. The different portions 21-24 are each produced separately, and thereafter mounted to a metal support structure 25 to provide a side skirt assembly. The metal support structure 25 is configured to provide sufficient mechanical properties both in the longitudinal direction, and transversal direction, of the side skirt assembly. The different portions 21-24 may be made of SMC, and constitutes modularized components. This means that if a side skirt of longer longitudinal extension is desired, an additional central portion (such as portions 22 or 23) may be added.

In contrast to the side skirt shown in FIG. 2, a side skirt produced in accordance with the method described herein need not consist of a plurality of separately produced longitudinal portions assembled together. Instead, a side skirt (or any other drag-reduction device for a heavy vehicle as described herein) may be made of one single body consisting of continuous fiber reinforced plastic. Furthermore, by the herein described method, the drag-reduction device need not comprise any metal support structure. This in turn results in a reduction of weight and, if desired, more available space onboard the vehicle for accommodating other components. This is a result of both material selection and selection of production method. More specifically, the herein described method for producing a drag-reduction device, such as a side skirt, utilizes a plurality of sub-preforms of a specific configuration ensuring that the desired mechanical strength in various directions of the drag-reduction device is obtained. The use of a plurality of sub-preforms when producing the drag-reduction device enables modularization. For example, the plurality of sub-preforms may have different longitudinal extensions, different number of third tape layers, and/or different number and/or type of layers extending over the whole length and width of the sub-preform. In accordance with the herein described method, the plurality of sub-preforms are arranged side-by-side or in a partially overlapping arrangement. Thereby, the first and second tape layers of a first sub-preform is extended by the first and second tape layers of a second sub-preform adjacent the first sub-preform, which in turn results in longitudinally extending reinforcement zones along the sides of the produced drag-reduction device.

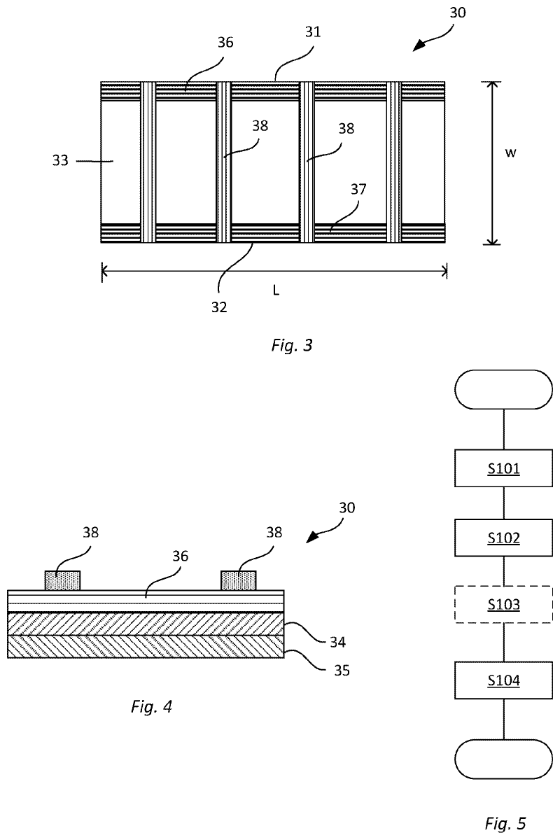

FIG. 3 schematically illustrates a top view of an exemplifying embodiment of a sub-preform 30 which may be used in the herein described method for producing a drag-reduction device for a heavy vehicle. The illustrated sub-preform is a substantially flat sub-preform 30 having a length L (i.e. extension in longitudinal direction) and a width w. The width w may essentially correspond to the width of the drag-reduction device to be produced. However, the length L of the sub-preform 30 is considerably shorter than the longitudinal extension of the drag-reduction device to be produced.

The sub-preform comprises a first longitudinal side 31 and an opposing second longitudinal side 32. The sub-preform may have a rectangular area as shown in the figure. Alternatively, the sub-preform may have an area of a parallelogram. In case the sub-preform is intended to be arranged at a longitudinal end portion the drag-reduction device to be produced, other geometrical shapes are also plausible.

The sub-preform 30 comprises a stack of fiber-containing layers. More specifically, the sub-preform 30 comprises at least one layer 33 extending over the whole length Land width w of the sub-preform. In other words, the at least one layer 33 extends over the entire area of the sub-preform 30. The at least one layer 33 may for example be formed of a plurality of tape layers arranged adjacent each other so as together forming the layer, although the present disclosure is not limited to the at least one layer 33 being formed of tape layers. For example, the at least one layer 33 may alternatively comprise a weaved structure comprising continuous fibers. The sub-preform further comprises a first tape layer 36 extending in the longitudinal direction of the sub-preform 30 along the first longitudinal side 31 of the sub-preform. The first tape layer 36 extends over the entire length L and comprises unidirectional continuous fibers aligned with the longitudinal direction of the sub-preform. Furthermore, the sub-preform 30 comprises a second tape layer 37 arranged in parallel with and spaced-apart from the first tape layer 36. The second tape layer 37 extends along the second longitudinal side 32 of the sub-preform 30. Like the first tape layer 36, the second tape layer 37 comprises unidirectional continuous fibers aligned with the longitudinal direction of the sub-preform.

The sub-preform 30 further comprises a plurality of third tape layers 38 extending transversal to the longitudinal direction of the sub-preform. It should be noted that although the figured illustrates four such tape layers, the number of third tape layers may be 2, 3 or more than 4 without departing from the present disclosure. The number of third tape layers may for example be dependent of the length of the sub-preform 30 and/or the strength requirements of the drag-reduction device to be produced. The third tape layers 38 are arranged in parallel and spaced-apart from each other.

Furthermore, each of the plurality of third tape layers 38 comprises unidirectional continuous fibers aligned with the transversal direction of the sub-preform, i.e. aligned in the width direction of the sub-preform 30.

FIG. 4 schematically illustrates a cross-sectional view of a second exemplifying embodiment of a sub-preform 30 according to the present disclosure, taken close to and in parallel with a first longitudinal side of the sub-preform 30. The sub-preform according to the second exemplifying embodiment comprises, in addition to a first tape layer 36 and a second tape layer 37 (not visible in the figure) extending along a respective longitudinal side of the sub-preform and a plurality of third tape layers extending transversal to the first and second tape layers 36, 37, a fourth layer 34 and a fifth layer 35. Each of the fourth and fifth layers 34, 35 extends over the whole length and width of the sub-preform, i.e. over the whole area of the sub-preform. The fourth layer 34 comprises unidirectional continuous fibers oriented with an angle of from +30° to +60° with respect to the longitudinal direction of the sub-preform. The fifth layer 35 comprises unidirectional fibers oriented with an angle of from −30° to −60° with respect to the longitudinal direction of the sub-preform. The fourth and fifth layers 34, 35 may suitably be formed by automated tape layering to achieve the desired orientation of the fibers of the respective layers.

FIG. 5 represents a flowchart schematically illustrating an exemplifying embodiment of the herein described method for producing a drag-reduction device, such as a side skirt or a side air deflector. The method comprises a step S101 of providing a mold adapted to the geometrical configuration of the drag-reduction device to be produced. The method further comprises a step S102 of arranging a plurality of sub-preforms in said mold such that the sub-preforms are arranged side-by-side or in a partially overlapping arrangement, with a longitudinal direction of each of the plurality of sub-preforms corresponding to a longitudinal direction of the drag-reduction device to be produced. The method may also comprise a step S103 of providing a resin, either by resin application or resin infiltration, to the plurality of sub-preforms arranged in the mold. In case the sub-preforms are already fully impregnated with resin, step S103 may be omitted. The method thereafter comprises a step S104 of heat-treating so as to cure the resin. Thereby, the drag-reduction device is obtained.

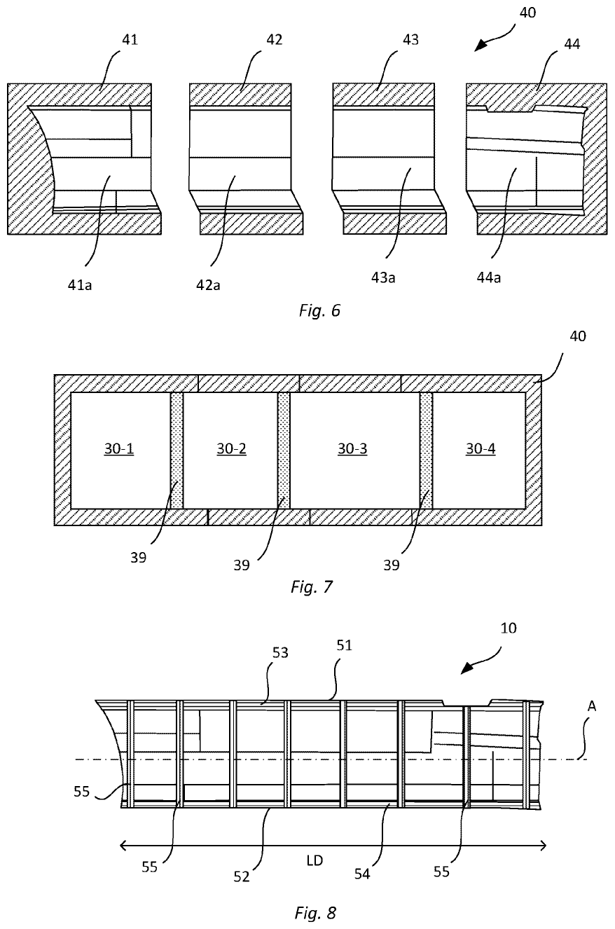

FIG. 6 schematically illustrates an exploded view of a mold 40 that may be used in the herein described method for producing a drag-reduction device. For sake of clarity and ease of illustration, only the female mold part of the mold is shown. It should however be noted that the mold typically also comprises a corresponding male mold part. The mold 40 comprises a plurality of modular mold sections 41, 42, 43, 44 which are assembled to form the mold. It should be noted that although only the female part of each modular mold section is shown in the figure, each modular mold section 41, 42, 43, 44 also comprises a corresponding male part. Each of the modular mold sections has a mold surface corresponding to the geometrical configuration of a predefined longitudinal portion of the drag-reduction device to be produced, which in the present example is a side skirt for a heavy vehicle. More specifically, the plurality of mold sections comprises a first mold section 41 having a mold surface 41a corresponding to a first longitudinal end portion of the side skirt. The plurality of mold sections further comprises a second mold section 42 and a third mold section, each having a respective mold surface 42a, 43a, corresponding a longitudinal portion present between the opposing longitudinal end portions of the side skirt to be produced. Moreover, the plurality of mold sections comprises a fourth mold section 44 having a mold surface 44a corresponding to a second longitudinal end portion (opposing the first longitudinal end portion) of the side skirt.

In order to adapt to a desired length and geometrical configuration of the drag-reduction device to be produced, one of the modular mold sections 42 and 43 may be omitted, replaced by an alternative modular mold section, and/or one or more additional modular mold sections may be added. The modular mold sections may be assembled side-by-side along the longitudinal direction of the drag-reduction device to be produced.

Using a modular mold sections in order to adapt to the variety of different sizes and configurations of drag-reduction devices to be produced reduces the tooling costs and thus also the overall production costs.

FIG. 7 schematically illustrates a top view of an example of how a plurality of individual sub-preforms 30 may be arranged in a mold, such as the mold 40 shown in FIG. 6. In the figure, four sub-preforms are used, these being numbered as 30-1 to 30-4 for the purpose of distinguishing them from each other. The sub-preforms are in the example arranged in a partially overlapping arrangement, the overlapping regions marked with reference number 39. Furthermore, the sub-preforms are arranged such that their longitudinal directions corresponds to the longitudinal direction of the drag-reduction to be produced. The fact that the sub-preforms are arranged so as to partially overlap ensures sufficient mechanical strength in the longitudinal direction of the drag-reduction device as there will be no interruption between the first and second tape layers of one sub-preform and the first and second tape layers of an adjacent sub-preform when the production of the drag-reduction device has been completed.

According to an alternative to an overlapping arrangement, the plurality of sub-preforms may be arranged side-by-side as seen in the longitudinal direction thereof. If so, one or more additional fiber containing layers should preferably arranged on top of, or below, the plurality of sub-preforms in order to ensure desired mechanical strength in the longitudinal direction of the produced drag-reduction device. Such additional fiber containing layer(s) should be provided in the mold before the step of heat treating so as to cure the resin. It should however be noted that a partially overlapping arrangement of the plurality of sub-preforms is preferred.

After the plurality of sub-preforms have been arranged in the mold, parts thereof that may possibly extend outside of the mold surface may be removed by trimming in accordance with conventional techniques therefore.

FIG. 8 schematically illustrates a side view of one exemplifying embodiment of the drag-reduction device according to the present disclosure, more specifically a side skirt 10 for a heavy vehicle. The illustrated side skirt 10 may be produced in accordance with the above described method for producing a drag-reduction device. The side skirt has a longitudinal direction LD as shown in the figure.

The side skirt 10 comprises a first reinforcement zone 53, extending along a first longitudinal side 51 of the side skirt 10. Said first reinforcement zone 53 comprises unidirectional continuous fibers aligned parallel to a longitudinal axis A of the side skirt 10. The side skirt 10 further comprises a second reinforcement zone 54 extending along a second longitudinal 52 of the side skirt. Like the first reinforcement zone 53, the second reinforcement zone comprises unidirectional continuous fibers aligned parallel to a longitudinal axis A of the side skirt 10. Furthermore, the side skirt 10 comprises a plurality of third reinforcement zones 55, spaced-apart from each other along the longitudinal axis A of the side skirt 10. In the figure, eight reinforcement zones 55 are illustrated. Each of the third reinforcement zones 55 comprises unidirectional continuous fibers aligned transversal to the longitudinal axis A of the side skirt.

1. A method of producing a drag-reduction device for a heavy vehicle, the method comprising the following steps:
providing a mold adapted to a geometrical configuration of the drag-reduction device to be produced;
arranging a plurality of sub-preforms in said mold such that the sub-preforms are arranged side-by-side or in a partially overlapping arrangement, with a longitudinal direction of each of the plurality of sub-preforms corresponding to a longitudinal direction of the drag-reduction device to be produced;
providing a resin, either by resin application or resin infiltration, to the plurality of sub-preforms arranged in the mold unless the plurality of sub-preforms are already fully impregnated with said resin; and
heat treating so as to cure the resin,
wherein each sub-preform of the plurality of sub-preforms comprises a stack of fiber-containing layers, said fiber-containing layers comprising:
one or more layers extending over an entire length and width of the sub-preform;
a first tape layer extending in the longitudinal direction of the sub-preform along a first longitudinal side of, and over the entire length of the sub-preform;
a second tape layer arranged in parallel with and spaced-apart from the first tape layer the second tape layer extending along a second longitudinal side of, and over the entire length of the sub-preform; and
a plurality of third tape layers extending transversal to the longitudinal direction of the sub-preform, said plurality of third tape layers arranged in parallel and spaced-apart from each other; and
wherein each of the first tape layer and the second tape layer comprises unidirectional continuous fibers aligned with the longitudinal direction of the sub-preform, and
wherein each of the plurality of third tape layers comprises unidirectional continuous fibers aligned with a transversal direction of the sub-preform.

2. The method according to claim 1, wherein the drag-reduction device is a side skirt or a side air deflector

3. The method according to claim 1, wherein each of the plurality of third tape layers extends between the first and second longitudinal sides of the sub-preform.

4. The method according to claim 1, wherein said one or more layers extending over the entire length and width of the sub-preform comprises:
a fourth layer comprising unidirectional fibers oriented with an angle of from +30° to +60° with respect to the longitudinal direction of the sub-preform ; and
a fifth layer comprising unidirectional fibers oriented with an angle of from −30° to −60° with respect to the longitudinal direction of the sub-preform.

5. The method according to claim 1, claims, wherein each sub-preform of the plurality of sub-preforms is a pre-consolidated sub-preform.

6. The method according to claim 1, further comprising producing each of the plurality of sub-preforms by automated tape layering.

7. The method according to claim 1, wherein providing a mold adapted to the geometrical configuration of the drag-reduction device to be produced comprises assembling a plurality of modular mold sections.

8. The method according to claim 7, wherein each of the plurality of modular mold sections has a mold surface corresponding to the geometrical configuration of a predefined longitudinal portion of the drag-reduction device to be produced.

9. A drag-reduction device for a land-based heavy vehicle, the drag-reduction device having a longitudinal axis and two opposing longitudinal sides and being made of a fiber reinforced material, wherein in that the drag-reduction device comprises:
a first reinforcement zone, extending along a first longitudinal side of the two opposing longitudinal sides, said first reinforcement zone comprising unidirectional continuous fibers aligned parallel to the longitudinal axis of the drag-reduction device;
a second reinforcement zone, extending along a second longitudinal side of the two opposing longitudinal sides and being spaced-apart from the first reinforcement zone, said second reinforcement zone comprising unidirectional continuous fibers aligned parallel to the longitudinal axis of the drag-reduction device; and
a plurality of third reinforcement zones spaced-apart from each other along the longitudinal axis of the drag-reduction device each comprising unidirectional continuous fibers aligned transversal to the longitudinal axis of the drag-reduction device.

10. The drag-reduction device according to claim 9, wherein the drag-reduction device is a side skirt or a side air deflector for a heavy vehicle.

11. The drag-reduction device according to claim 9, having a longitudinal extension of at least 1.5 meters.

12. A vehicle comprising a drag-reduction device for a land-based heavy vehicle, the drag-reduction device having a longitudinal axis and two opposing longitudinal sides and being made of a fiber reinforced material, wherein the drag-reduction device comprises:
a first reinforcement zone, extending along a first longitudinal side of the two opposing longitudinal sides, said first reinforcement zone comprising unidirectional continuous fibers aligned parallel to the longitudinal axis of the drag-reduction device;
a second reinforcement zone, extending along a second longitudinal side of the two opposing longitudinal sides and being spaced-apart from the first reinforcement zone, said second reinforcement zone comprising unidirectional continuous fibers aligned parallel to the longitudinal axis of the drag-reduction device; and
a plurality of third reinforcement zones, spaced-apart from each other along the longitudinal axis of the drag-reduction device, each comprising unidirectional continuous fibers aligned transversal to the longitudinal axis of the drag-reduction device.

13. The vehicle according to claim 12, wherein the drag-reduction device is a side skirt or a side air deflector.

14. The vehicle according to claim 12, having a longitudinal extension of at least 1.5 meters.
